(19) United States
(12) Patent Application Publication
(10) Pub. No.: US 2021/0160654 A1
(43) Pub. Date: May 27, 2021

(54) SERVER, INFORMATION PROCESSING SYSTEM, NON-TRANSITORY COMPUTER-READABLE MEDIUM, AND CONTROL METHOD

(71) Applicant: TOYOTA JIDOSHA KABUSHIKI KAISHA, Toyota-shi (JP)

(72) Inventors: Hiromitsu FUJII, Kariya-shi (JP); Kohei MIWA, Nisshin-shi (JP); Yuko MIZUNO, Nagoya-shi (JP); Shinsuke ARIGA, Nagoya-shi (JP); Hirotaka OMISHA, Nisshin-shi (JP); Tsuyoshi OKADA, Nagoya-shi (JP)

(73) Assignee: TOYOTA JIDOSHA KABUSHIKI KAISHA, Toyota-shi (JP)

(21) Appl. No.: 17/087,401

(22) Filed: Nov. 2, 2020

(30) Foreign Application Priority Data
Nov. 25, 2019 (JP) 2019-212601

(51) Int. Cl. H04W 4/021; H04L 29/08; G06T 11/00; G06Q 30/06; G06Q 30/02; G06Q 50/14; G06F 16/29; G06F 16/9537

(52) U.S. Cl. CPC H04W 4/021; H04L 67/306; G06T 11/00; G06Q 30/0623; G06Q 30/0633; G06Q 30/0641; G06T 2200/24; G06Q 30/0205; G06Q 50/14; G06F 16/29; G06F 16/9537; G06T 2200/16; G06Q 30/0639

(57) ABSTRACT

A server is communicably connected to a plurality of terminal apparatuses and includes a server controller. The server controller is configured to: determine that the plurality of terminal apparatuses are within a same geographical area; transmit, to each terminal apparatus in the plurality of terminal apparatuses, display content that is at least partially different per terminal apparatus. The display content is determined based on attribute information pertaining to respective users of the plurality of terminal apparatuses and on the geographical area.

### CROSS-REFERENCE TO RELATED APPLICATION

This application claims priority to Japanese Patent Application No. 2019-212601 (filed on Nov. 25, 2019), the entire contents of which are incorporated herein by reference.

### TECHNICAL FIELD

The present disclosure relates to a server, an information processing system, a program, and a control method.

### BACKGROUND

Navigation apparatuses that propose a travel plan, provide route guidance when the proposed travel plan is selected by a user, and receive a satisfaction rating from the user after completion of the route guidance are known (for example, Patent Literature [PTL] 1).

### CITATION LIST

### Patent Literature

PTL 1: JP 2009-258026 A

### SUMMARY

According to PTL 1, above, it is disclosed that the proposal of the travel plan is made for a single user. Assuming, however, that a plurality of users tour a single geographical area (e.g., sightseeing spot), not every user will be satisfied with the same travel plan, depending on their generation, preference, or the like. There is, therefore, room for improvement in the method described in PTL 1.

It would be helpful to provide a server, an information processing system, a program, and a control method that are capable of presenting, for each of the plurality of users who are in the same geographical area, content that is suitable for the user.

A server according to an embodiment of the present disclosure is communicably connected to a plurality of terminal apparatuses and includes a server configured to:
determine that the plurality of terminal apparatuses are within a same geographical area; and
transmit, to each terminal apparatus in the plurality of terminal apparatuses, display content that is at least partially different per terminal apparatus, the display content being determined based on attribute information pertaining to respective users of the plurality of terminal apparatuses and on the geographical area.

A program according to an embodiment of the present disclosure is configured to cause a computer, as a server that is communicably connected to a plurality of terminal apparatuses, to execute operations including:
determining that the plurality of terminal apparatuses are within a same geographical area; and
transmitting, to each terminal apparatus in the plurality of terminal apparatuses, display content that is at least partially different per terminal apparatus, the display content being determined based on attribute information pertaining to respective users of the plurality of terminal apparatuses and on the geographical area.

A control method according to an embodiment of the present disclosure is performed by a server that is communicably connected to a plurality of terminal apparatuses. The control method includes:
determining that the plurality of terminal apparatuses are within a same geographical area; and
transmitting, to each terminal apparatus in the plurality of terminal apparatuses, display content that is at least partially different per terminal apparatus, the display content being determined based on attribute information pertaining to respective users of the plurality of terminal apparatuses and on the geographical area.

A server, an information processing system, a program, and a control method according to an embodiment of the present disclosure may present, for each of the plurality of users who is in the same geographical area, content that is suitable for the user.

### BRIEF DESCRIPTION OF THE DRAWINGS

In the accompanying drawings:

FIG. 1 is a schematic diagram of an information processing system;

FIG. 2 is a function block diagram of a first terminal apparatus;

FIG. 3 is a function block diagram of a second terminal apparatus;

FIG. 4 is a function block diagram of a server;

FIG. 5 illustrates an example of a display screen on the first terminal apparatus;

FIG. 6 illustrates a configuration of a content database;

FIG. 7 illustrates another example of the display screen on the first terminal apparatus;

FIG. 8 illustrates different display content on the first terminal apparatus and the second terminal apparatus;

FIG. 9 illustrates an example of scenery and the display screen on the first terminal apparatus; and

FIG. 10 is a flowchart illustrating operations of a server.

### DETAILED DESCRIPTION

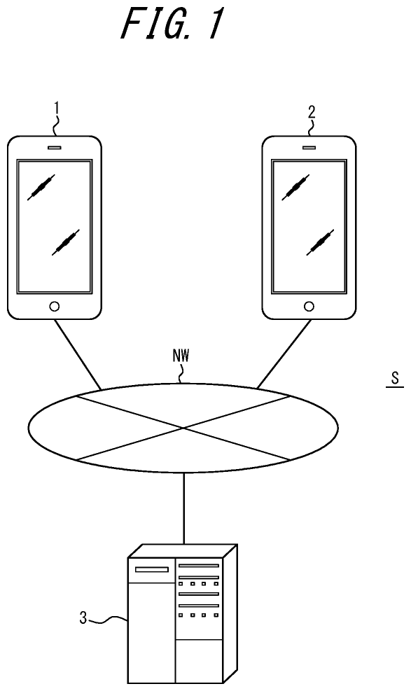

FIG. 1 is a schematic diagram of an information processing system S according to an embodiment. The information processing system S includes a single first terminal apparatus 1, a second terminal apparatus 2, and a server 3, which are connectable to each other. In FIG. 1, a single first terminal apparatus 1, a single second terminal apparatus 2, and a single server 3 are illustrated for convenience of explanation. However, the number of first terminal apparatuses 1, the number of second terminal apparatuses 2, and the number of servers 3 are not limited to one. The first terminal apparatus 1 and the second terminal apparatus 2 are portable. The first terminal apparatus 1, the second terminal apparatus 2, and the server 3 are capable of communicating with each other, for example, via a network NW which includes a mobile communication network, the Internet, or the like.

An outline of processing that is executed by the server 3 according to the present embodiment will be described. A server controller 31 of the server 3 is configured to determine that the first terminal apparatus 1 and the second terminal apparatus 2 are within the same geographical area, and determine display content for the first terminal apparatus 1 and display content for the second terminal apparatus 2 that is at least partially different from each other, based on attribute information pertaining to respective users of the first terminal apparatus 1 and the second terminal apparatus 2 and on the geographical area. The server controller 31 is configured to transmit the determined display content to the first terminal apparatus 1 and the second terminal apparatus 2. The above configuration allows the server 3 to present, for the plurality of users who are in the same geographical area (e.g., the same sightseeing spot), content that is suitable for differing attributes (e.g., age, interest etc.) of the users. The server controller 31 is therefore able to present, for each user, content that the users find interesting, thereby improving user satisfaction.

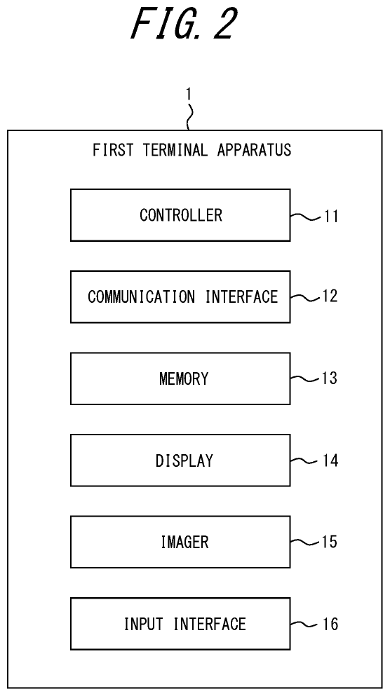

With reference to FIG. 2, an internal configuration of the first terminal apparatus 1 is described in detail.

The first terminal apparatus 1 includes a controller 11, a communication interface 12, a memory 13, a display 14, an imager 15, and an input interface 16. These functional parts are communicably connected to each other, for example, via a dedicated line.

The controller 11 includes, for example, one or more general-purpose processors, such as a Central Processing Unit (CPU) or a Micro Processing Unit (MPU), or one or more dedicated processors that are dedicated to specific processing. The controller 11 is not limited to a processor and may include one or more dedicated circuits. Examples of dedicated circuits may include a Field-Programmable Gate Array (FPGA) and an Application Specific Integrated Circuit (ASIC).

The communication interface 12 includes one or more communication modules for connection to the network NW that conform to wired or wireless Local Area Network (LAN) standards. Alternatively, the communication interface 12 may include a module conforming to one or more mobile communication standards, such as the 4th Generation (4G) or the 5th Generation (5G) standards. The communication interface 12 may also include a communication module conforming to near field communications, such as Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 is configured to transmit and receive any information (e.g., position information obtained using Global Positioning System [GPS]) via the network NW.

The memory 13 may be, but is not limited to, a semiconductor memory, a magnetic memory, or an optical memory. The memory 13 may function as, for example, a main memory, an auxiliary memory, or a cache memory. The memory 13 may store information resulting from analysis or processing performed by the controller 11. The memory 13 may also store various types of information, etc., regarding operations and control of the first terminal apparatus 1. The memory 13 may store a system program, an application program, embedded software, etc.

The display 14 is a display interface (e.g., panel display). The display 14 is configured to display an image captured by the imager 15, information generated by the controller 11, information read from the memory 13, or the like. The display 14 is configured to display the display content acquired from the server 3 by superimposing the display content on an image captured by the imager 15.

The imager 15 includes a camera and is configured to capture an image of surrounding scenery, a person, or the like. The imager 15 is configured to transmit the captured image to the display 14. The imager 15 may store the captured image in the memory 13 or transmit the captured image to the controller 11 for the purpose of analysis.

The input interface 16 includes one or more input interfaces that detect a user input and send input information to the controller 11. Examples of input interfaces may include, but are not limited to, physical keys, capacitive keys, a touch screen integrally provided in the panel display, a microphone that receives audio input, and an IC card reader.

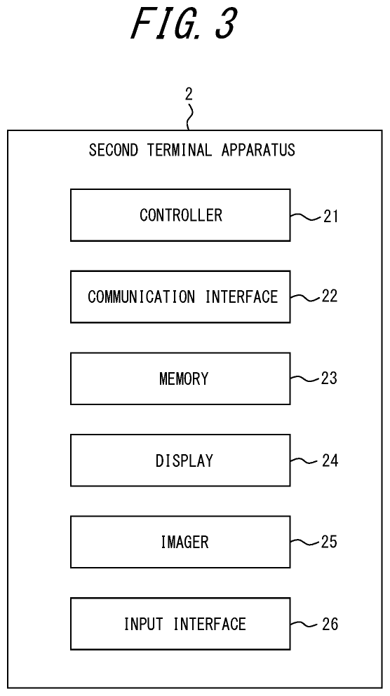

With reference to FIG. 3, an internal configuration of the second terminal apparatus 2 is described.

The second terminal apparatus 2 includes a controller 21, a communication interface 22, a memory 23, a display 24, an imager 25, and an input interface 26. These functional parts are communicably connected to each other, for example, via a dedicated line. Hardware configurations of the controller 21, the communication interface 22, the memory 23, the display 24, the imager 25, and the input interface 26 are identical to those of the controller 11, the communication interface 12, the memory 13, the display 14, the imager 15, and the input interface 16. A description thereof is therefore omitted here.

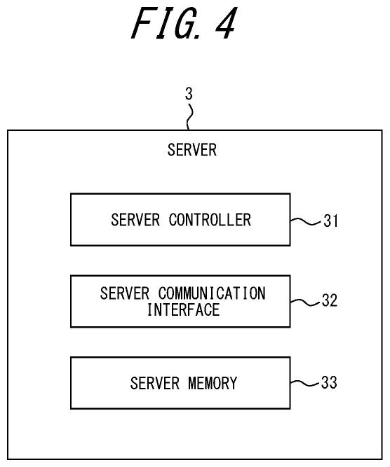

With reference to FIG. 4, an internal configuration of the server 3 is described in detail.

The server 3 includes a server controller 31, a server communication interface 32, and a server memory 33. These functional parts are communicably connected to each other.

The server controller 31 includes, for example, one or more general-purpose processors, such as a CPU or an MPU, or one or more dedicated processors that are dedicated for specific processing. The server controller 31 is not limited to processors and may include one or more dedicated circuits. Examples of such dedicated circuits may include an FPGA and an ASIC.

The server communication interface 32 includes one or more communication modules, for connection to the network NW, that conform to wired or wireless LAN standards, or a module conforming to mobile communication standards, such as 4G or 5G. The server communication interface 32 may include a communication module conforming to near field communication standards, such as Bluetooth®, AirDrop®, IrDA, ZigBee®, Felica®, or RFID. In the present embodiment, the server 3 is connected to the network NW via the server communication interface 32. The server communication interface 32 is configured to transmit and receive any information via the network NW.

The server memory 33 may be, but is not limited to, a semiconductor memory, a magnetic memory, or an optical memory. The server memory 33 may function as, for example, a main memory, an auxiliary memory, or a cache memory. The server memory 33 may store information resulting from analysis or processing performed by the server controller 31. The server memory 33 may also store various types of information regarding operations and control of the server 3. The server memory 33 may store a system program, an application program, embedded software, etc. The server memory 33 stores a content database (DB). The content DB contains display content to be displayed in the first terminal apparatus 1 and the second terminal apparatus 2.

A description is given in detail of processing executed in the information processing system S according to the present embodiment. As an example, it is assumed that a first user who is in possession of the first terminal apparatus 1 is a father of a second user who is in possession of the second terminal apparatus 2. The father and the child are travelling together to Kyoto and are at the Kiyomizu Temple.

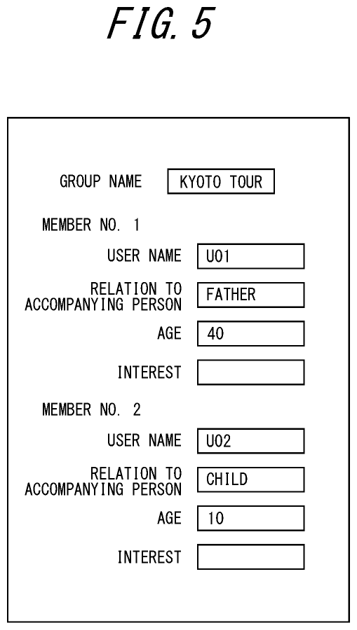

As illustrated in FIG. 5, upon receiving a user instruction, the first terminal apparatus 1 displays, on the display 14, an input screen for attribute information. The attribute information includes usernames, relations to accompanying persons, ages, and interests. The attribute information may further include identification information (e.g., IP addresses) used to identify the terminals. The first terminal apparatus 1 receives, from the first user, the following input: username “U01”; relation to accompanying person “father”; and age “40”. The first terminal apparatus 1 also receives, as the attribute information also pertaining to the second user, the following input: username “U02”; relation to accompanying person “child”; and age “10”. The first terminal apparatus 1 transmits the inputted attribute information to the server 3. As an alternative example, the first terminal apparatus 1 may transmit, to the second terminal apparatus 2, screen information required for input of the attribute information also pertaining to the second user, and the second terminal apparatus 2 may receive input of the attribute information. The second terminal apparatus 2 transmits the inputted attribute information to the server 3.

The first terminal apparatus 1 and the second terminal apparatus 2 transmit position information to the server 3. The server controller 31 determines, based on the transmitted position information, that the first terminal apparatus 1 and the second terminal apparatus 2 are within the same geographical area, and then registers, in the server memory 33, the attribute information and the position information, in association with the first user and the second user.

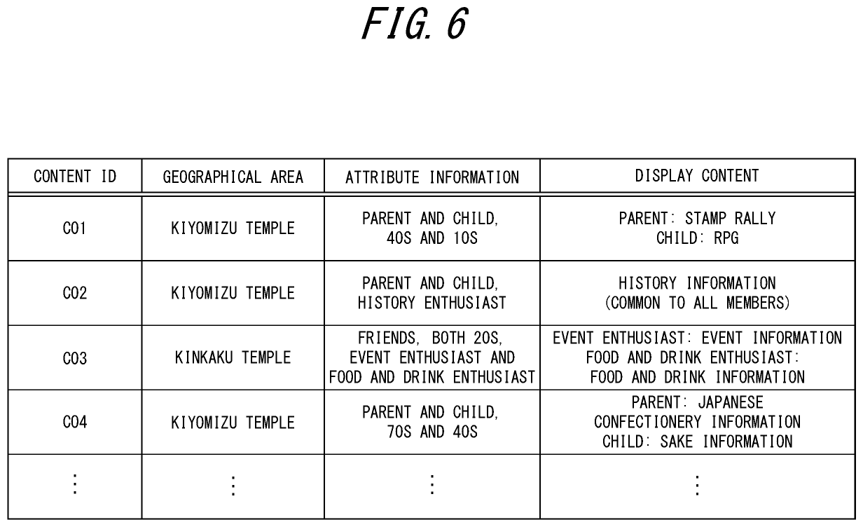

As illustrated in FIG. 6, the server controller 31 stores, in advance, in the content DB in the server memory 33, display content to be transmitted to a plurality of terminal apparatuses, in association with geographical areas and attribute information. The content DB stores the geographical areas, the attribute information, and the display content, in association with a plurality of content IDs. The geographical areas refer to areas in which the terminal apparatuses may be determined to be present based on the respective position information. Each geographical area may be a place name, such as “Kiyomizu Temple” or “Kinkaku Temple”. As an alternative example, each geographical area may be an address, a combination of a latitude and a longitude, a city name, and/or a postcode. The attribute information includes information inputted with respect to the first user and the second user. The display content may include (still or moving) images to be displayed on the display 14 of the first terminal apparatus 1 and the display 24 of the second terminal apparatus 2, or audio to be outputted from the first terminal apparatus 1 and the second terminal apparatus 2.

The server controller 31 retrieves, from the server memory 33, attribute information and position information pertaining to the first user and the second user. Based on the retrieved information, the server controller 31 determines display content to be transmitted to the first terminal apparatus 1 and the second terminal apparatus 2. Specifically, the server controller 31 extracts, from the content DB, any content that satisfies both the attribute information and the position information that have been retrieved from the server memory 33. In the above example in which the first user is a father in his 40s, the second user is a child in his or her 10s, and both the first user and the second user are at Kiyomizu Temple, the server controller 31 extracts, as the corresponding content, Content C01 and Content C02, as illustrated in FIG. 6.

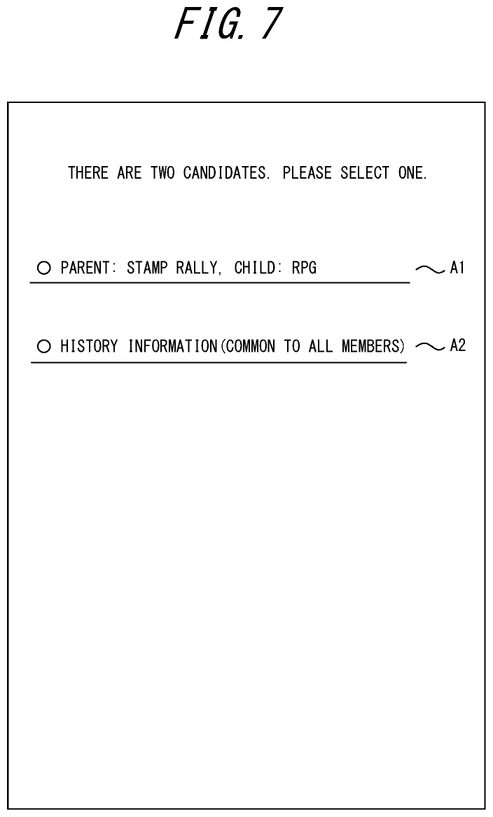

As illustrated in FIG. 7, the server controller 31 presents, on the display 14 of the first terminal apparatus 1, Candidate A1, which corresponds to the extracted Content C01, and Candidate A2, which corresponds to the extracted Content C02, in a selectable manner. At this time, the first user and the second user may view the candidates on the display 14. Alternatively or additionally, the server controller 31 may present the extracted Content 01 and Content C02 on the display 24 of the second terminal apparatus 2.

The display 14 displays that either one of Candidates A1 and A2 is to be selected. For example, as illustrated in FIG. 7, the display 14 displays “There are two candidates. Please select one.” as text.

The display 14 may present Candidates A1 and A2 in descending order of rate of concordance with the inputted attribute information. Specifically, the attribute information corresponding to Candidate A1 concords with the inputted information in terms of the two aspects of the information “parent and child” and “40s and 10s.” In this case, the rate of concordance is 100%. On the other hand, the attribute information corresponding to Candidate A2, although in concordance with the inputted information in terms of the information “parent and child”, does not concord with the inputted information in terms of the information “history enthusiast”. In this case, the rate of concordance is 50%. Accordingly, as illustrated in FIG. 7, the display 14 presents Candidate A1, which has the higher rate of concordance, above Candidate A2 on the screen.

Candidate A1 includes content for the first user and content for the second user that are at least partially different from each other. Specifically, the content to be displayed for the first user and the content to be displayed for the second user may be completely different from each other or may partially include common content. Candidate A2 includes shared content that is displayable in common by all the members (e.g., the first user and the second user herein). As illustrated in FIG. 7, the display 14 may present Candidate A2 distinguishable from Candidate A1 by, for example, adding “This is common to all the members.” as a description.

Upon receiving a selection of one of the candidates, the first terminal apparatus 1 transmits the result of the selection to the server 3. As an example herein, a case in which Candidate A1 has been selected will be described.

The server controller 31 transmits, to the first terminal apparatus 1 and the second terminal apparatus 2, the display content corresponding to the selected Candidate A1. As an example herein, the server controller 31 transmits stamp rally content (Content P1) to the first terminal apparatus 1 and transmits Role-Playing Game (RPG) content (Content P2) to the second terminal apparatus 2.

The first terminal apparatus 1 and the second terminal apparatus 2 respectively display, on the display 14 and the display 24, that the imager 15 and the imager 25 are to be activated and turned toward scenery. At this time, the imager 15 and the imager 25 each capture an image of the scenery and display the captured image on the display 14 or the display 24.

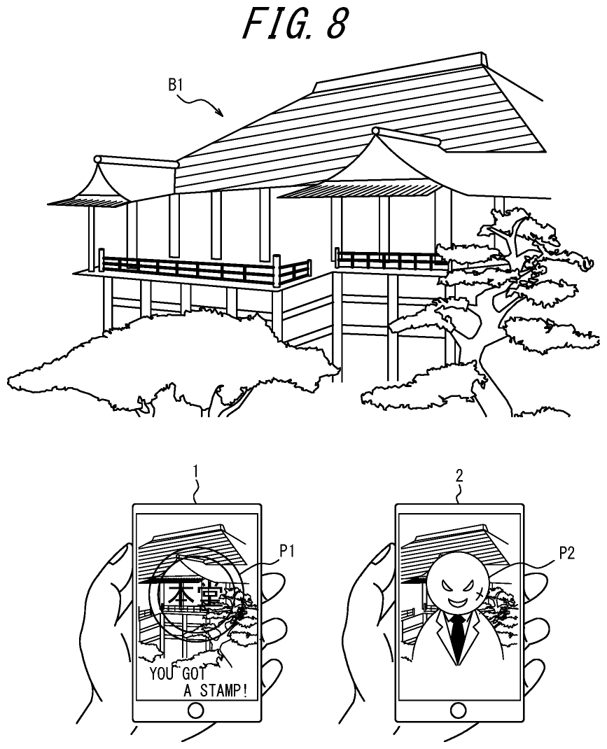

As illustrated in FIG. 8, each of the first terminal apparatus 1 and the second terminal apparatus 2 displays the determined display content by superimposing the display content on the captured image of Kiyomizu Temple. The superimposing processing may employ so-called Augmented Reality (AR) techniques. For example, each of the first terminal apparatus 1 and the second terminal apparatus 2 determines a display mode of the display content received from the server 3, according to posture information of the terminal acquired from an acceleration sensor, inclination information acquired by a magnetic sensor, angular velocity information acquired by a gyro sensor, feature points of the scenery in the captured image, a marker placed at a building and read from the captured image, etc.

The display 14 displays that a stamp for the rally stamp has been acquired as the display content. The display 24 displays a boss character of the RPG as the display content.

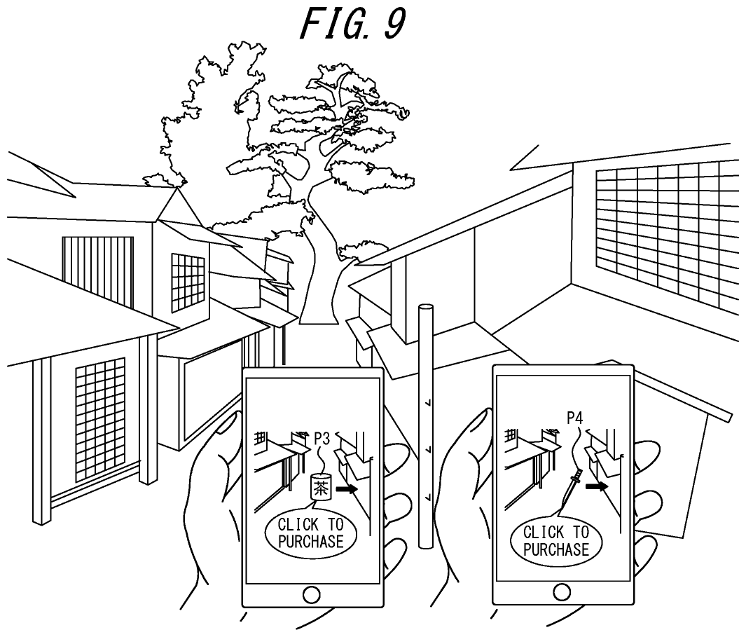

The first terminal apparatus 1 and the second terminal apparatus 2 move to another geographical area. As illustrated in FIG. 9, the first terminal apparatus 1 and the second terminal apparatus 2 may display Content P3 and Content P4, which each pertain to a product (e.g., food and drink, clothes, or a weapon) or a service that, when selected for example by clicking, is purchasable, by superimposing Content P3 and Content P4 on the captured images. Upon receiving a user selection of Content P3 or Content P4, each of the first terminal apparatus 1 and the second terminal apparatus 2 displays a purchasing screen for the corresponding product or service. Upon receiving a purchase instruction, each of the first terminal apparatus 1 and the second terminal apparatus 2 executes purchase processing with a predetermined server via the network NW.

In another example, the first terminal apparatus 1 and the second terminal apparatus 2 may display information pertaining to a function or an event (e.g., a sightseeing event, such as a festival) that is associated with the geographical area, by superimposing the information on the captured images.

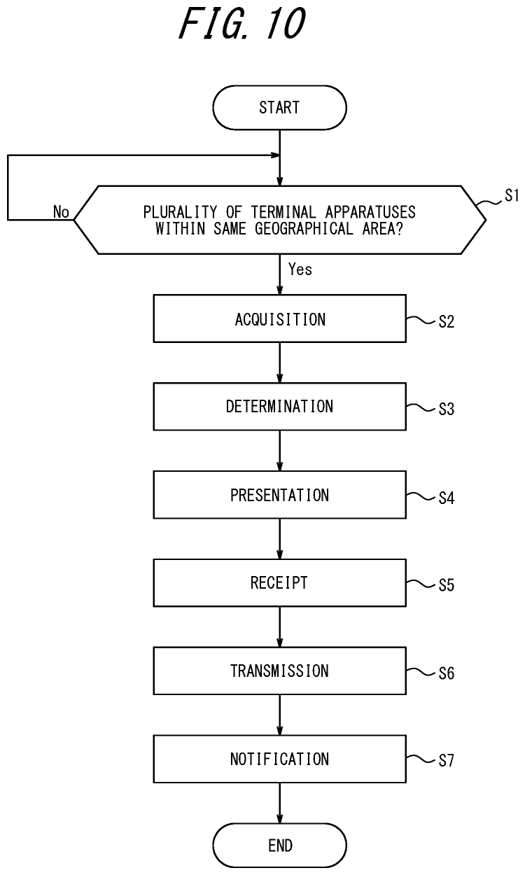

With reference to FIG. 10, a control method, performed by the server 3, is described.

In Step S1, the server controller 31 determines whether or not the first terminal apparatus 1 and the second terminal apparatus 2 are within the same geographical area, based on the position information for the first terminal apparatus 1 and the second terminal apparatus 2.

If a determination result is “yes” in Step S1, the process moves to Step S2, in which the server controller 31 acquires the attribute information inputted to the first terminal apparatus 1 and/or the second terminal apparatus 2.

In Step S3, the server controller 31 determines the display content to be displayed on each of the first terminal apparatus 1 and the second terminal apparatus 2, based on the geographical area and the attribute information.

In Step S4, the server controller 31 presents, to each of the first terminal apparatus 1 and the second terminal apparatus 2, the plurality of candidates for the display content.

In Step S5, the server controller 31 receives the selection of one of the plurality of candidates.

In Step S6, the server controller 31 transmits, to each of the first terminal apparatus 1 and the second terminal apparatus 2, the display content corresponding to the selected candidate.

In Step S7, the server controller 31 notifies the first terminal apparatus 1 and the second terminal apparatus 2 of the information (e.g., information pertaining to a product, a service, a function, or an event) that is associated with the geographical area in which the first terminal apparatus 1 and the second terminal apparatus 2 are present.

As has been described, according to the present embodiment, the server 3 is configured to determine that the first terminal apparatus 1 and the second terminal apparatus 2 are within the same geographical area and determine display content for the first terminal apparatus 1 and display content for the second terminal apparatus 2 that are at least partially different from each other, based on the attribute information pertaining to the respective users of the terminal apparatuses and on the geographical area. The server 3 is configured to transmit the determined display content to the first terminal apparatus 1 and the second terminal apparatus 2. The above configuration allows the server 3 to present, for a plurality of users who are in the same geographical area (e.g., the same sightseeing spot), content that is suitable for the differing attributes (e.g., age, interest, etc.) of the users. The server 3 is therefore able to display, for each user, content that the users find interesting, thereby improving user satisfaction.

Furthermore, according to the present embodiment, the display content is displayed by each of the plurality of terminal apparatuses by being superimposed on respective images captured by the plurality of terminal apparatuses. The above configuration allows the server 3 to display the display content in combination with real-world scenery, thereby further improving user experience.

Moreover, according to the present embodiment, the server controller 31 is further configured to present, to at least one of the plurality of terminal apparatuses, a plurality of candidates for the display content in a selectable manner. The above configuration allows the server 3 to enable each user to select content reflecting the interest or the like of the user, thereby improving user satisfaction.

Moreover, according to the present embodiment, at least one of the plurality of candidates includes shared content that is displayable in common by the plurality of terminal apparatuses. The at least one of the plurality of candidates that includes the shared content is presented so as to be distinguishable from other candidates. The above configuration makes distinguishable the shared content that is displayable in common, and the server controller 31 enables the plurality of users to select the shared content and share the same experience.

Moreover, according to the above embodiment, the server controller 31 is configured to present, to the at least one of the plurality of terminal apparatuses, the plurality of candidates in descending order of rate of concordance with the attribute information. The above configuration allows the server controller 31 to present the content in descending order of suitability for each user, thereby enabling the user to find content that the user finds interesting.

Moreover, according to the present embodiment, the display content includes information pertaining to a product or a service that is associated with the geographical area and that, when selected, is purchasable. The display content may include information pertaining to a function or an event that is associated with the geographical area. The above configuration allows the server controller 31 to assist the plurality of users in knowing or enjoying the geographical area, thereby improving user experience.

While the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined together or divided.

For example, in the above embodiment, a program that executes all or part of the functions or processing of the first terminal apparatus 1, the second terminal apparatus 2, or the server 3 may be recorded on a computer-readable recording medium. The computer-readable recording medium includes a non-transitory computer-readable medium and may be a magnetic recording apparatus, an optical disc, a magneto-optical recording medium, or a semiconductor memory. The program may be distributed, for example, by selling, transferring, or renting a portable recording medium, such as a Digital Versatile Disc (DVD) or a Compact Disc Read Only Memory (CD-ROM), on which the program is recorded. The program may also be distributed by storing the program in a storage of the server and transmitting the program from the server to another computer. The program may also be provided as a program product. The present disclosure may also be implemented as a program that can be executed by a processor.

In the above embodiment, the first terminal apparatus 1 and the second terminal apparatus 2 superimpose the display content on the images captured by the imager 15 and the imager 25. As an alternative example, however, the first terminal apparatus 1 and the second terminal apparatus 2 may display the display content without using the images captured by the imager 15 and the imager 25.

1. A server that is communicably connected to a plurality of terminal apparatuses, the server comprising a server controller configured to:
determine that the plurality of terminal apparatuses are within a same geographical area; and
transmit, to each terminal apparatus in the plurality of terminal apparatuses, display content that is at least partially different per terminal apparatus, the display content being determined based on attribute information pertaining to respective users of the plurality of terminal apparatuses and on the geographical area.

2. The server according to claim 1, wherein
the display content is displayed by the plurality of terminal apparatuses by being superimposed on respective images captured by the plurality of terminal apparatuses.

3. The server according to claim 1, wherein
the server controller is configured to present, to at least one of the plurality of terminal apparatuses, a plurality of candidates for the display content in a selectable manner.

4. The server according to claim 3, wherein
at least one of the plurality of candidates includes shared content that is displayable in common by the plurality of terminal apparatuses, and
the at least one of the plurality of candidates that includes the shared content is presented so as to be distinguishable from other candidates.

5. The server according to claim 3, wherein
the server controller is configured to present, to the at least one of the plurality of terminal apparatuses, the plurality of candidates in descending order of rate of concordance with the attribute information.

6. The server according to claim 1, wherein
the display content includes information pertaining to a product or a service that is associated with the geographical area and that, when selected, is purchasable.

7. The server according to claim 1, wherein
the display content includes information pertaining to a function or an event that is associated with the geographical area.

8. An information processing system comprising:
the server according to claim 1; and
the plurality of terminal apparatuses.

9. A non-transitory computer-readable medium storing a program configured to cause a computer, as a server that is communicably connected to a plurality of terminal apparatuses, to execute operations comprising:
determining that the plurality of terminal apparatuses are within a same geographical area; and
transmitting, to each terminal apparatus in the plurality of terminal apparatuses, display content that is at least partially different per terminal apparatus, the display content being determined based on attribute information pertaining to respective users of the plurality of terminal apparatuses and on the geographical area.

10. The non-transitory computer-readable medium according to claim 9, wherein
the display content is displayed by the plurality of terminal apparatuses by being superimposed on respective images captured by the plurality of terminal apparatuses.

11. The non-transitory computer-readable medium according to claim 9, the operations further comprising
presenting, to at least one of the plurality of terminal apparatuses, a plurality of candidates for the plurality of pieces of display content in a selectable manner.

12. The non-transitory computer-readable medium according to claim 11, wherein
at least one of the plurality of candidates includes a piece of shared content that is displayable in common by the plurality of terminal apparatuses, and
the at least one of the plurality of candidates that includes the piece of shared content is presented so as to be distinguishable from other candidates.

13. The non-transitory computer-readable medium according to claim 11, the operations further comprising
presenting, to the at least one of the plurality of terminal apparatuses, the plurality of candidates in descending order of rate of concordance with the attribute information.

14. The non-transitory computer-readable medium according to claim 9, wherein
the display content includes information pertaining to a product or a service that is associated with the geographical area and that, when selected, is purchasable.

15. A control method performed by a server that is communicably connected to a plurality of terminal apparatuses, the control method comprising:
determining that the plurality of terminal apparatuses are within a same geographical area; and
transmitting, to each terminal apparatus in the plurality of terminal apparatuses, display content that is at least partially different per terminal apparatus, the display content being determined based on attribute information pertaining to respective users of the plurality of terminal apparatuses and on the geographical area.

16. The control method according to claim 15, wherein
the display content is displayed by the plurality of terminal apparatuses by being superimposed on respective images captured by the plurality of terminal apparatuses.

17. The control method according to claim 15, further comprising
presenting, to at least one of the plurality of terminal apparatuses, a plurality of candidates for the display content in a selectable manner.

18. The control method according to claim 17, wherein
at least one of the plurality of candidates includes shared content that is displayable in common by the plurality of terminal apparatuses, and
the at least one of the plurality of candidates that includes the shared content is presented so as to be distinguishable from other candidates.

19. The control method according to claim 17, further comprising
presenting, to the at least one of the plurality of terminal apparatuses, the plurality of candidates in descending order of rate of concordance with the attribute information.

20. The control method according to claim 15, wherein
the display content includes information pertaining to a product or a service that is associated with the geographical area and that, when selected, is purchasable.
